(19) United States
(12) Patent Application Publication
(10) Pub. No.: US 2015/0015454 A1
(43) Pub. Date: Jan. 15, 2015

(54) WIRELESS COMMUNICATION DEVICE HAVING TWO ANTENNAS

(71) Applicant: FIH (Hong Kong) Limited, Kowloon (HK)

(72) Inventors: CHIH-YANG TSAI, New Taipei (TW); CHUAN-CHOU CHI, New Taipei (TW); CHAO-WEI HO, New Taipei (TW); CHI-SHENG LIU, New Taipei (TW); PAI-CHENG HUANG, New Taipei (TW); HAO-YING CHANG, New Taipei (TW)

(21) Appl. No.: 14/325,976

(22) Filed: Jul. 8, 2014

(30) Foreign Application Priority Data
Jul. 15, 2013 (TW) 102125162

(51) Int. Cl. H01Q 21/28

(52) U.S. Cl. CPC H01Q 21/28
USPC 343/893

(57) ABSTRACT

A wireless communication device includes a printed circuit board (PCB), a main antenna, an auxiliary antenna, and a metal member. The main antenna, the auxiliary antenna, and the metal member are positioned on the PCB. The metal member is spaced from the auxiliary antenna to allow current to be coupled from the auxiliary antenna to the metal member. Thus, the main antenna and the auxiliary antenna jointly form an orthographic electromagnetic field.

### FIELD

The disclosure generally relates to wireless communication device, and particularly to a wireless communication device having two antennas.

### BACKGROUND

Long term evolution (LTE) antennas are used in wireless communication devices such as mobile phones, and multiple input multiple output (MIMO) technologies are employed in the LTE antennas. However, the LTE antennas may be influenced by electromagnetic field of other antennas. Thus, an envelope correlation coefficient (ECC) between the LTE antennas and the other antennas is increased.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an isometric view of an embodiment of a wireless communication device.

FIG. 2 is a view illustrating a 3-dimensional radiation pattern of the wireless communication device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

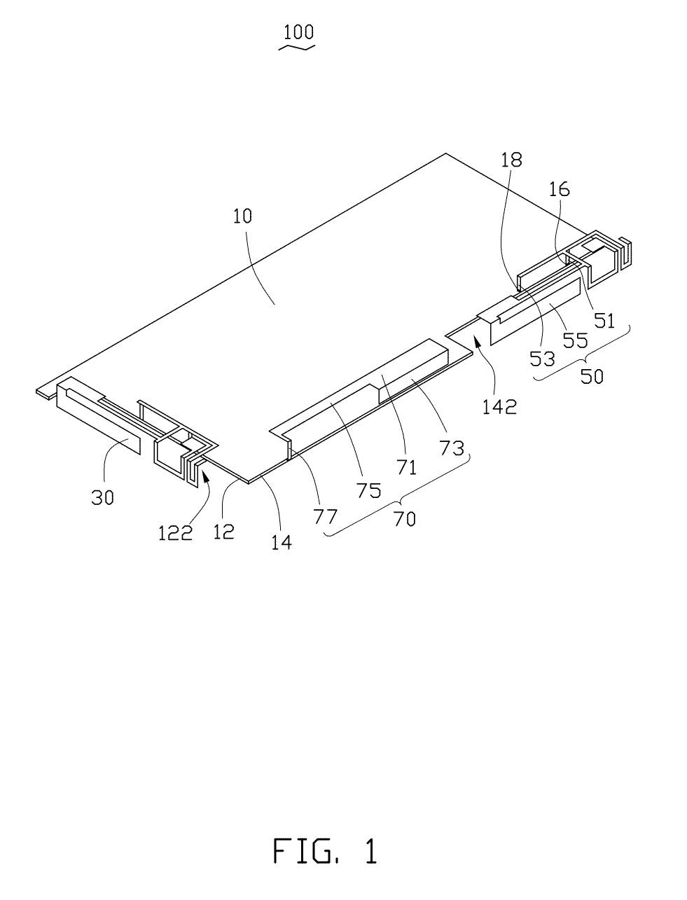

FIG. 1 shows an embodiment of a wireless communication device 100. The wireless communication device 100 can be a mobile phone or a personal digital assistant, for example.

The wireless communication device 100 includes a printed circuit board (PCB) 10, a main antenna 30, an auxiliary antenna 50, and metal member 70. The main antenna 30, the auxiliary antenna 50, and the metal member 70 are positioned on the PCB 10. The main antenna 30 and the auxiliary antenna 50 constitute a multiple input multiple output (MIMO) system for working simultaneously.

The PCB 10 includes a first edge 12 and a second edge 14. The second edge 14 is connected substantially perpendicularly to the first edge 12, and a length of the second edge 14 is greater than a length of the first edge 12. The first edge 12 defines a first notch 122, and the second edge 14 defines a second notch 142. The PCB 10 forms a feed pin 16 and a ground pin 18 adjacent to second notch 142. The feed pin 16 provides current to the auxiliary antenna 50, and the auxiliary antenna 50 is grounded by the ground pin 18.

The main antenna 30 can be any structure, such as a planar inverted-F (PIFA) structure, or a monopole structure, for example. The main antenna 30 receives wireless signals at 3G and 4G bands, such as an LTE band. In at least one embodiment, the main antenna 30 extends substantially parallel to the first edge 12, and is located at the first notch 122. The main antenna 30 is electronically connected to the PCB 10 to obtain current. A direction of main current flowing on the main antenna 30 is parallel to the first edge 12. The direction of the main current of the main antenna 30 indicates a majority current direction selected from transverse current and longitudinal current flowing on the main antenna 30.

In at least one embodiment, a structure of the auxiliary antenna 50 is substantially the same structure as the main antenna 30, and is configured to receive wireless signals at the LTE band. The auxiliary antenna 50 includes a feed end 51, a ground end 53, and a radiator 55. The feed end 51 is connected substantially perpendicularly to the feed pin 16. The ground end 53 is connected substantially perpendicularly to the ground pin 18. The radiator 55 is connected to the feed end 51 and the ground end 53. In at least one embodiment, the auxiliary antenna 50 extends substantially parallel to the second edge 14, and is located at the second notch 142. Thus, the auxiliary antenna 50 is substantially perpendicular to the main antenna 30. A direction of main current flowing on the auxiliary antenna 50 is parallel to the second edge 14. The direction of the main current of the auxiliary antenna 50 indicates a majority current direction selected from transverse current and longitudinal current flowing on the auxiliary antenna 50.

The metal member 70 is located above the second edge 14 of the PCB 10, and extends substantially parallel to the second edge 14. The metal member 70 includes a first sheet 71, a second sheet 73, an extending sheet 75, and a ground section 77. The first sheet 71 is substantially parallel to the second edge 14. The second sheet 73 is connected to the first sheet 71, and a plane of the second sheet 73 is substantially perpendicular to a plane of the first sheet 71. In at least one embodiment, the first sheet 71 and the second sheet 73 are positioned adjacent to the second notch 142, and are spaced from the radiator 55 of the auxiliary antenna 50. Thus, the current of the auxiliary antenna 50 can be coupled to the metal member 70. The extending sheet 75 is connected to an end of the first sheet 71 opposite to the auxiliary antenna 50, and extends far away from the auxiliary antenna 50. The ground section 77 is connected substantially perpendicularly between the extending sheet 75 and a ground plane (not shown) of the PCB 10, to support and ground the metal member 70.

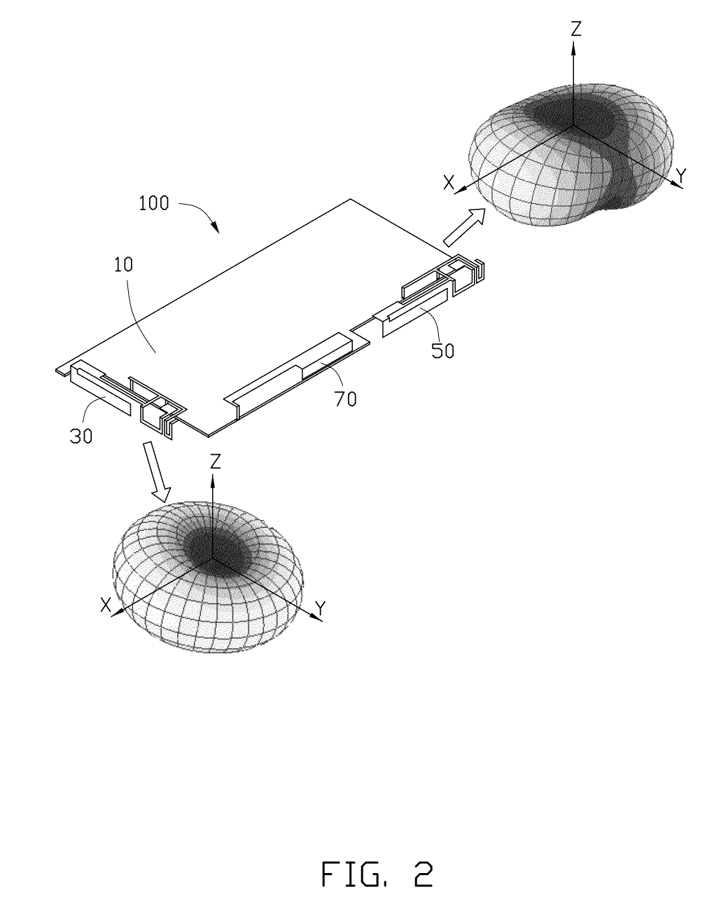

FIG. 2 shows that a “Y” axis is defined to be parallel to the first edge 12, an “X” axis is defined to be parallel to the second edge 14, and a “Z” axis is defined to be perpendicular to a surface of the PCB 10. If the metal member 70 is not positioned on the PCB 10, both directions of maximum electromagnetic fields of the main antenna 30 and the auxiliary antenna 50 are along the “Y” axis. Thus, the main antenna 30 and the auxiliary antenna 50 may be influenced by each other, and an envelope correlation coefficient (ECC) between the main antenna 30 and the auxiliary antenna 50 is increased. However, when the metal member 70 is positioned on the PCB 10, the current of the auxiliary antenna 50 is coupled to the metal member 70, an electromagnetic field along the “Y” axis of the auxiliary antenna 50 is decreased, and an electromagnetic field along the “X” axis of the auxiliary antenna 50 is increased. Thus, the direction of the maximum electromagnetic field of the auxiliary antenna 50 is along the “X” axis, and is substantially perpendicular to the direction of the maximum electromagnetic field of the main antenna 30, thereby forming an orthographic electromagnetic field. Thus, the ECC between the main antenna 30 and the auxiliary antenna 50 is decreased.

Table 1 sets out ECC relations between the main antenna 30 and the auxiliary antenna 50, in one state the wireless communication device without the metal member 70, and in another state the wireless communication device with the metal member 70:

| | Frequencies (MHz) | | | | | |
|---|---|---|---|---|---|---|
| | 796 | 806 | 816 | 874 | 881.5 | 889 |
| ECC of the | 0.7975 | 0.7575 | 0.6981 | 0.4190 | 0.4079 | 0.3972 |
| wireless | | | | | | |
| communication | | | | | | |
| device without | | | | | | |
| the metal | | | | | | |
| member 70 | | | | | | |
| ECC of the | 0.5583 | 0.4752 | 0.4162 | 0.3518 | 0.3597 | 0.3681 |
| wireless | | | | | | |
| communication | | | | | | |
| device with | | | | | | |
| the metal | | | | | | |
| member 70 | | | | | | |

In at least one embodiment, the structure of the auxiliary antenna 50 is different from the main antenna 30.

Since the metal member 70 is positioned on the PCB 10, and is adjacent to the auxiliary antenna 50, the current of the auxiliary antenna 50 can be coupled to the metal member 70, thereby changing the maximum electromagnetic field of the auxiliary antenna 50. Thus, an orthographic electromagnetic field between the main antenna 30 and the auxiliary antenna 70 is formed, and the ECC between the main antenna 30 and the auxiliary antenna 70 is significantly reduced, therefore, the receiving/transmitting efficiency of the wireless communication device 100 will not be negatively influenced.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A wireless communication device, comprising:
a printed circuit board (PCB);
a main antenna positioned on the PCB;
an auxiliary antenna positioned on the PCB; and
a metal member positioned on the PCB and spaced from the auxiliary antenna;
wherein current flowing on the auxiliary antenna is coupled to the metal member to allow the main antenna and the auxiliary antenna to jointly form an orthographic electromagnetic field.

2. The wireless communication device as claimed in claim 1, wherein the PCB comprises a first edge defining a first notch, the main antenna extends parallel to the first edge, and the main antenna is located at the first notch.

3. The wireless communication device as claimed in claim 2, wherein the PCB comprises a second edge perpendicular to the first edge, the second edge defines a second notch, the auxiliary antenna extends parallel to the second edge, and the auxiliary antenna is located at the second notch.

4. The wireless communication device as claimed in claim 3, wherein the PCB forms a feed pin and a ground pin, the auxiliary antenna comprises a feed end, a ground end, and a radiator, the feed end is connected to the feed pin, the ground end is connected to the ground pin, and the radiator is connected to the feed end and the ground end.

5. The wireless communication device as claimed in claim 4, wherein the metal member is located above the second edge of the PCB, and extends parallel to the second edge.

6. The wireless communication device as claimed in claim 5, wherein the metal member comprises a first sheet, a second sheet, an extending sheet, and a ground section, the first sheet is parallel to the second edge, the second sheet is connected to the first sheet, and a plane of the second sheet is perpendicular to a plane of the first sheet, the extending sheet is connected to an end of the first sheet opposite to the auxiliary antenna, and extends far away from the auxiliary antenna, the ground section is connected perpendicularly between the extending sheet and the PCB.

7. The wireless communication device as claimed in claim 6, wherein the first sheet and the second sheet are positioned adjacent to the second notch, and are spaced from the radiator of the auxiliary antenna.

8. The wireless communication device as claimed in claim 1, wherein the main antenna and the auxiliary antenna constitute a multiple input multiple output (MIMO) system.

9. A wireless communication device, comprising:
a printed circuit board (PCB);
a main antenna positioned on the PCB;
an auxiliary antenna positioned on the PCB; and
a metal member positioned on the PCB and adjacent to the auxiliary antenna;
wherein current flowing on the auxiliary antenna is coupled to the metal member, a direction of a maximum electromagnetic field of the auxiliary antenna is perpendicular to a direction of a maximum electromagnetic field of the main antenna.

10. The wireless communication device as claimed in claim 9, wherein the PCB comprises a first edge defining a first notch, the main antenna extends parallel to the first edge, and the main antenna is located at the first notch.

11. The wireless communication device as claimed in claim 10, wherein the PCB comprises a second edge perpendicular to the first edge, the second edge defines a second notch, the auxiliary antenna extends parallel to the second edge, and the auxiliary antenna is located at the second notch.

12. The wireless communication device as claimed in claim 11, wherein the PCB forms a feed pin and a ground pin, the auxiliary antenna comprises a feed end, a ground end, and a radiator, the feed end is connected to the feed pin, the ground end is connected to the ground pin, and the radiator is connected to the feed end and the ground end.

13. The wireless communication device as claimed in claim 12, wherein the metal member is located above the second edge of the PCB, and extends parallel to the second edge.

14. The wireless communication device as claimed in claim 13, wherein the metal member comprises a first sheet, a second sheet, an extending sheet, and a ground section, the first sheet is parallel to the second edge, the second sheet is connected to the first sheet, and a plane of the second sheet is perpendicular to a plane of the first sheet, the extending sheet is connected to an end of the first sheet opposite to the auxiliary antenna, and extends far away from the auxiliary antenna, the ground section is connected perpendicularly between the extending sheet and the PCB.

15. The wireless communication device as claimed in claim 14, wherein the first sheet and the second sheet are positioned adjacent to the second notch, and are spaced from the radiator of the auxiliary antenna.
